(19) United States
(12) Patent Application Publication
(10) Pub. No.: US 2008/0036600 A1
(43) Pub. Date: Feb. 14, 2008

(54) RELATED INFORMATION PRESENTING SYSTEM

(75) Inventor: Tsutomu OHYAMA, Kanagawa (JP)

Correspondence Address: SUGHRUE-265550, 2100 PENNSYLVANIA AVE. NW, WASHINGTON, DC, 20037-3213, US

(73) Assignee: FUJI XEROX CO., LTD., Tokyo (JP)

(21) Appl. No.: 11/756,889

(22) Filed: Jun. 1, 2007

(30) Foreign Application Priority Data
Aug. 11, 2006 (JP) 2006-219265

(51) Int. Cl. G08B 13/14

(52) U.S. Cl. 340/572.1

(57) ABSTRACT

A related information presenting system includes identification devices and an information presenting apparatus The identification devices are provided in respective materials distributed to users. Each identification device stores an identifier that specifies presentation information relating to the corresponding material so that the identifier is wirelessly readable The information presenting apparatus includes a presentation information storage unit, a reading unit, a searching unit and a presenting unit. The presentation information storage unit stores the presentation information corresponding to the identifiers. The reading unit wirelessly reads an identifier from the identification device that exists within a proximity range of the reading unit. The searching unit searches the presentation information storage unit for presentation information corresponding to the read identifier. The presenting unit outputs found presentation information visually.

### CROSS-REFERENCE TO RELATED APPLICATIONS

This application is based on and claims priority under 35 U.S.C. §119 from Japanese Patent Application No. 2006-219265 filed Aug. 11, 2006.

### BACKGROUND

1. Technical Field

The invention relates to a technique for presenting related information to a user having a distributed material such as a brochure r which does not have the information which specifies an individual. Specifically, the invention relates to a technique that can supply detailed information or timely information on written contents of, for example, a brochure to a user.

2. Related Art

An identification device that stores an identifier wirelessly readable has been put to practical use. The identification device is called an ID tag, an IC card, or the like.

For example, an identification device is configured to be excited by electromagnetic waves or the like output from a reading apparatus existing within its proximity range so that identification information stored in the identification device can be wirelessly read out in a non-contact state.

The identification device to be excited by the reading apparatus as described above can easily be made small and light because the identification device itself does not need to have a power source. For this reason, identification devices made small and light are attached to commodities sold in a store for the purpose of sales management of the commodities, or attached to delivered articles for the purpose of delivery management in distribution of articles.

### SUMMARY

According to an aspect of the invention, a related information presenting system includes identification devices and an information presenting apparatus. The identification devices are provided in respective materials distributed to users. Each identification device stores an identifier that specifies presentation information relating to the corresponding material so that the identifier is wirelessly readable. The information presenting apparatus includes a presentation information storage unit, a reading unit, a searching unit and a presenting unit. The presentation information storage unit stores the presentation information corresponding to the identitiers. The reading unit wirelessly reads an identifier from the identification device that exists within a proximity range of the reading unit. The searching unit searches the presentation information storage unit for presentation information corresponding to the read identifier. The presenting unit outputs found presentation information visually.

### BRIEF DESCRIPTION OF THE DRAWINGS

Exemplary embodiments of the invention will be described below in detail with reference to the accompanying drawings, wherein:

FIG. 1 is a view illustrating the functional configuration of a related information presenting system according to an exemplary embodiment of the invention;

FIG. 2 is a view illustrating an outline of the related information presenting system according to the exemplary embodiment of the invention;

FIG. 3 is a view explaining an operation process of the related information presenting system according to the exemplary embodiment of the invention; and

FIG. 4A is a view illustrating an example of a screen display of the related information presenting system according to the exemplary embodiment of the invention, and FIG. 4B is a view illustrating an example of a screen display of the related information presenting system according to the exemplary embodiment of the invention.

### DETAILED DESCRIPTION

Hereinafter, exemplary embodiments of the invention will be described in detail.

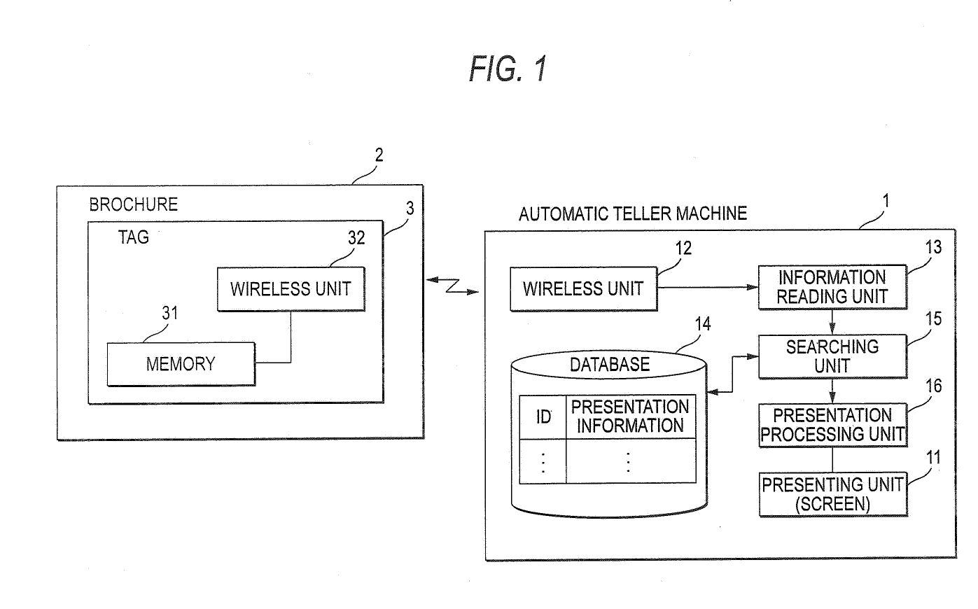

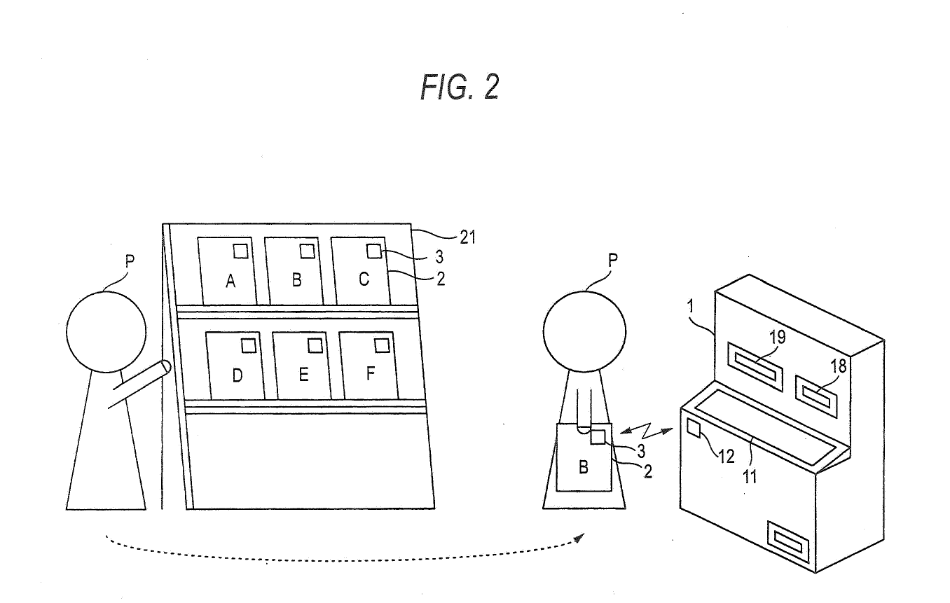

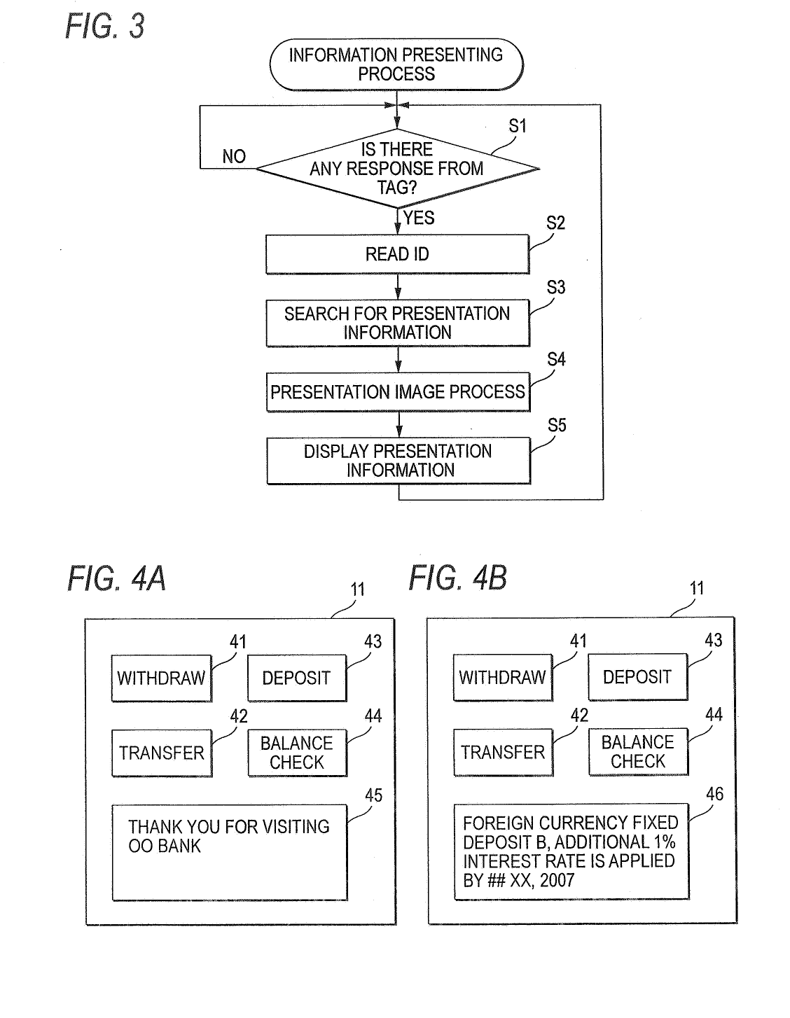

FIG. 1 is a view illustrating the functional configuration of a related information presenting system according to the exemplary embodiment. FIG. 2 is a view illustrating an outline of the related information presenting system according to the exemplary embodiment. FIG. 3 is a view illustrating procedures of the according to the exemplary embodiment. FIGS. 4A and 4B are views illustrating examples of a screen display of the related information presenting system according to the exemplary embodiment.

In addition, functions of an information presenting apparatus according to another embodiment of the invention are realized by causing a computer to execute a program according to still another embodiment.

Referring to FIG. 2, the system according to the exemplary embodiment is applied to an automatic teller machine in a bank. In this case, the information presenting apparatus is realized by an automatic teller machine 1 Also, an identification device that stores an identifier wirelessly readable is realized by an ID tag 3 attached to a brochure 2 that is a material distributed to a user.

Brochures for various kinds of financial commodities provided by a bank are prepared, and the brochures 2 are put on a rack 21 located in a place easily noticed by users that use the automatic teller machine 1, such as a place where a user P who uses the automatic teller machine 1 waits in a queue.

Further, in the exemplary embodiment, brochures (printed materials for product information) for financial commodities that are intangible service products are used as an example. However, in the invention, the distributed materials may be a brochure for a tangible product or may be a material provided to a user, such as a souvenir, an instrument for lease, or the like.

The ID tag 3 is a small device that has a size of several square centimeters. The ID tag 3 includes a memory 31 that stores an identifier (ID) and a wireless unit 32 that wirelessly transmits the identifier (ID) stored in the memory 31.

In the ID tag 3, an identifier (ID) for specifying a type of a brochure to which the ID tag 3 is attached is stored in the memory 31. The identifier (ID) is readout in a non-contact method by a reading function (reader function) of the automatic teller machine 1, as will be described later.

The automatic teller machine 1 includes a screen 11 that displays and outputs information to a user and provides user interface that accepts user's touch input. For example, the automatic teller machine 1 may display operation buttons on the screen 11 so that a user can select any one of the operation buttons by the user's touch operation, and display and output information related to the brochure 2 on the screen 11.

In addition, in FIG. 2, reference numeral 18 denotes a slot for inserting a cash card thereinto, and reference numeral 19 denotes a slot for inserting an account passbook thereinto.

The automatic teller machine 1 includes a wireless unit 12, an information reading unit 13, a database 14, a searching unit 15 and a presentation processing unit 16. The wireless unit 12 accesses the ID tag 3 existing within a proximity range of the wireless unit 12 (the automatic teller machine 1). The information reading unit 13 wirelessly reads an identifier (ID) stored in the memory 31 of the ID tag 3 through the wireless unit 12. The database 14 stores (i) each identifiers (IDs) for specifying a type of the corresponding brochure and (ii) corresponding related information (presentation information) that is to be displayed on the screen 11 and that relates to contents of the corresponding brochure, in association with each other. The searching unit 15 searches the database 14 for the related information (presentation information) corresponding to the identifier (ID) read from the ID tag 3. The presentation processing unit 16 outputs the found related information (presentation information), a required operation button, and the like so as to be displayed on the screen 11.

In this case, the proximity range where the wireless unit 12 can access the ID tag 3 may be set to an existence position (for example, 30 cm or less) of the user P who operates the automatic teller machine 1. The point is that the proximity range is set so that the ID tag 3 of the brochure 2 that the user P holds is accessed.

In addition, the wireless unit 12 may be provided in a position facing the user P who operates the automatic teller machine 1 as shown in FIG. 2.

Further, in the exemplary embodiment, the database 14 is built in the automatic teller machine 1. However, the database 14 may he provided in a server on a network so that single or plural automatic teller machines 1 can access the database 14 through the network to search for and acquire corresponding related information (presentation information). That is, the database 14 for the automatic teller machine 1 may be included in the same automatic teller machine 1 or may be provided as a separate apparatus.

Furthermore, it is possible to appropriately change information, which is displayed on the screen 11 so as to be presented to a user, by changing the related information (presentation information) stored in the database 14. However, in the case of providing the database 14 through a separate server, it becomes easier to perform an operation of changing the related information (presentation information). In addition, in the case where the database 14 is shared among the plural automatic teller machines 1, it is possible to collectively perform an operation of changing the related information (presentation information) to be presented by the automatic teller machines 1.

FIG. 3 illustrates procedures of a process performed by the related information presenting system having the configuration described above.

When the user P who desires to use the automatic teller machine 1 picks out the brochure 2 (shown as a financial product B in FIG. 2) which the user P is interested in while waiting in a queue and then uses the automatic teller machine 1 in a state where the user P holds the brochure 2, the ID tag 3 attached to the brochure 2 is located within the access range of the wireless unit 12 provided in the automatic teller machine 1.

Since the wireless unit 12 of the automatic teller machine 1 emits an electric wave all the time, the ID tag 3 that receives the electric wave is excited. As a result, the identifier (ID) stored in the memory 31 is transmitted from the wireless unit 32 (step S1).

Then, the automatic teller machine 1 receives the identifier (ID) that has been transmitted from the wireless unit 12 by the ID tag 3, and then the information reading unit 13 acquires the identifier (ID) (step S2).

Then, the searching unit 15 searches the database 14 using the identifier (ID) acquired by the information reading unit 13 and acquires corresponding presentation information (step S3).

Then, the presentation processing unit 16 performs a necessary process, for example, for mixing the searched presentation information with a screen display image of the automatic teller machine 1 (step 84) and then output the process result so as to be displayed on the screen 11 (step S5).

FIGS. 4A and 4B illustrate specific examples of a screen display obtained by the process described above.

At normal time (that is, when the ID tag 3 is not accessed), operation guide information having contents shown in FIG. 4A is displayed on the screen 11 of the automatic teller machine 1.

That is, a ‘withdraw’ button image 41 indicating an operation button (soft key) used to perform an operation of withdrawing a deposit, a ‘transfer’ button image 42 indicating an operation button (soft key) used to perform an operation for transferring to another account, a ‘deposit’ button image 43 indicating an operation button (soft key) used to perform an operation of depositing money in an account, a ‘balance check’ button image 44 indicating an operation button (soft key) used to check a balance of an account, and a message ‘thank you for visiting 00 bank’ 45 that is set beforehand are displayed on the screen 11.

On the other hand, as described above, when the user P who holds the brochure 2 uses the automatic teller machine 1, an image including presentation information 46 shown in FIG. 4B is displayed on the screen 11.

That Is, in addition to the operation button images 41 to 44, information 46 indicating that ‘foreign currency fixed deposit B, additional 1% interest rate is applied by ## xx, 2007’ corresponding to the brochure (B) 2 that the user P holds is displayed on the screen 11 as presentation information. Thus, it is possible to present additional information on the foreign currency fixed deposit B to the user P who holds the brochure 2 of the foreign currency fixed deposit B.

In addition, in the example shown in FIG. 4B, the presentation information 46 is displayed instead of the display information 45 that is initially set. However the presentation information 46 may be displayed together with the display information 45, or the presentation information 46 may be displayed in a screen condition in which display information that is initially set does not exist.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The exemplary embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A related information presenting system comprising:
identification devices provided in respective materials distributed to users, each identification device that stores an identifier that specifies presentation information relating to the corresponding material so that the identifier is wirelessly readable; and
an information presenting apparatus comprising:
a presentation information storage unit that stores the presentation information corresponding to the identifiers;
a reading unit that wirelessly reads an identifier from the identification device that exists within a proximity range of the reading unit;
a searching unit that searches the presentation information storage unit for presentation information corresponding to the read identifier; and
a presenting unit that outputs found presentation information visually.

2. The system according to claim 1, wherein:
the presenting unit of the information presenting apparatus comprises a screen on which operation guide information for a user is displayed,
each material comprises a printed matter for product guide that is distributed to the user who uses the information presenting apparatus and
the presentation information corresponding to each identifier comprises information regarding the corresponding product guide.

3. An information presenting apparatus comprising:
a reading unit that wirelessly reads an identifier from an identification device existing within a proximity range of the reading unit, the identification device provided in a material distributed to a user, the identification device that stores the identifier that specifies presentation information relating to the material so that the identifier is wirelessly readable;
a searching unit that searches a presentation information storage unit that stores presentation information corresponding to identifiers for presentation information corresponding to the read identifier; and
a presenting unit that outputs found presentation information visually.

4. A computer readable medium storing a program causing a computer to execute a process for providing related information, the process comprising:
wirelessly reading an identifier from an identification device existing within a proximity range of the computer, the identification device provided in a material distributed to a user, the identification device that stores the identifier that specifies presentation information relating to the material so that the identifier is wirelessly readable;
searching a presentation information storage unit that stores presentation information corresponding to identifiers, for presentation information corresponding to the read identifier; and
outputting found presentation information visually.

5. A computer data signal embodied in a carrier wave for enabling a computer to perform a process for providing related information, the process comprising:
wirelessly reading an identifier from an identification device existing within a proximity range of the computer, the identification device provided in a material distributed to a user, the identification device that stores the identifier that specifies presentation information relating to the material so that the identifier is wirelessly readable;
searching a presentation information storage unit that stores presentation information corresponding to identifiers, for presentation information corresponding to the read identifier; and
outputting found presentation information visually.
